(19) United States
(12) Patent Application Publication
(10) Pub. No.: US 2014/0166843 A1
(43) Pub. Date: Jun. 19, 2014

(54) ADAPTIVE VELOCITY TRACKER

(71) Applicant: Rudi Bertocchi, Herzliya (IL)

(72) Inventor: Rudi Bertocchi, Herzliya (IL)

(21) Appl. No.: 13/720,043

(22) Filed: Dec. 19, 2012

(51) Int. Cl. F16M 11/18

(52) U.S. Cl. CPC F16M 11/18
USPC 248/550

(57) ABSTRACT

The disclosure is directed to a high precision two axis tracking system having adaptive angular velocity comprising: a pedestal coupled to a foundation; a slew drive comprising a modular velocity rotation driver operably coupled to the pedestal; an azimuth yoke operably coupled to the slew drive and hingedly coupled to an elevation hub; an elevation hub comprising a modular velocity elevation driver, hingedly coupled to the azimuth yoke; a directional apparatus configured to be precisely pointed towards a target, operably coupled to the elevation hub; and a processor operably coupled to the tracking system.

### BACKGROUND

The disclosure generally relates generally to spatial tracking systems and more particularly to numerically controlled two axis tracking systems

Present precision tracking devices with pointing accuracies better than 1 milliradian (mrad) may be generally divided into three families: (i) tracking devices for flight vehicles and/or missiles or other relatively fast moving targets (ii) tracking devices for earth orbiting satellites (low or high) or other quasi static targets and (iii) tracking devices for astronomical bodies or other virtually static targets. The principal difference between the types of tracking families lies in the angular velocity and angular acceleration of the tracked target. So called “solar trackers” for simple flat panel photovoltaic applications or other crude systems are deemed irrelevant to the following discussion due to their low accuracy.

Representative applications for the first family of tracking devices are radar and anti-aircraft defense systems. Said systems require high angular velocities to track fast-moving, relatively close targets, especially at low altitudes, which requires trading pointing accuracy for high angular rotational velocities and accelerations of the azimuth and elevation axes. Typical angular velocities and accuracies of such a tracking system may be represented by the ORBIT AL-4048 tracker, which may reach angular velocities of 15 deg/sec with pointing accuracy of ±1 mrad.

An example of the second family, e.g., earth orbiting satellite trackers, is the General Dynamics VA 18.3 meter antenna system. It has a turning head pedestal in an elevation over azimuth axis configuration. For this specific system the azimuthal rotation range is limited to 270 degrees, while the elevation range is 0-90 degrees. The pointing accuracy of said system is ±0.4 mrad. The angular velocities stated by the manufacturer are 1.5 deg/sec in azimuth and 10 deg/sec in elevation. The tracking system is mounted on a concrete tower. The described system is, therefore, very heavy, the antenna weighing 27 metric tons and the pedestal 32 metric tons. Furthermore, the electrical power required to operate the system is 120 kVA.

Space telescopes and deep space antennae represent the third family of tracking devices; the tracked target is distant, virtually static and has a very small viewing angle—demanding a very high pointing accuracy, 0.01-0.1 mrad. Such high pointing accuracy may be typically achieved by trading angular velocity for pointing accuracy. The ten meter antenna design of the National Radio Astronomy Observatory (NRAO) may be considered to represent one aspect of the current state of art in the design of tracking devices for high accuracy pointing. The claimed pointing accuracy of said antenna is about 5 μrad at a claimed maximum angular velocity of 6 deg/sec. The two axis tracking is performed by an elevation over azimuth system, with a yoke for enabling elevation and a plane bearing for azimuth motion. The yoke is manufactured from welded steel plates, causing large internal stresses due to the welding process which cannot be relieved by temperature baking and/or annealing due to the risk of structural deformations.

Likewise, the azimuth bearing of this antenna has a diameter of 2.4 m and deforms unless it is uniformly loaded. Furthermore, unless the bearing mounting faces are sufficiently stiff the weight of the structure will cause the bearing to be distorted regardless of how flat the mounting surfaces had been machined.

In the aforementioned tracking systems both the elevation and azimuth axes are driven by similar friction drives acting on a drive ring of each respective axis. This methodology of controlling the azimuth and elevation angle is plagued by several problems; (i) a single friction drive may not be sufficient to overcome the inherent friction of the system; (ii) that same friction drive may “burn out” if the drive friction momentarily peaks due to abrupt external loads such as wind gusts (especially with the large diameter antennae) or unbalanced mass distribution; (iii) the stiffness of the drive may be insufficient unless (expensive) carbide roller shafts are used; (iv) there is a risk of “welding” between the drive roller and the drive wheel; and (v) excessive thrust loading might be generated unless the roller axis is very carefully aligned, reducing the fault tolerance of the whole system. To sum, the proposed tracking device of the aforementioned system is very large and heavy, has large internal weld stresses which cannot be relieved without risking structural deformations and its drive system is likely to fail or degrade when subjected to unbalanced loads

An alternative methodology for pointing a large antenna may be the Jet Propulsion Lab's “Deep Space Station 15: Uranus” 34 meter antenna. It is equipped with an electrically driven azimuth-elevation type of tracking device. The antenna rotates in azimuth on four self-aligning wheel assemblies that ride on a precisely leveled circular steel track. The track is held in place by 16 tangential links that attach to a centrally reinforced concrete pedestal. The antenna steel structure is attached to an elevation bull gear wheel which drives it up and down. The operating speed of this antenna is 0.4 deg/s for both azimuth and elevation. It is obvious from the above that whilst being an acceptable solution for very large and heavy (in the order of hundreds of metric tons) antennae, it is far too complicated and expensive for commercial antennae.

Accordingly, a need arises for a tracking system where regardless of the distance to the target, pointing accuracy is not compromised, thereby being capable of tracking targets ranging from fast moving airplanes to virtually static astronomical entities at a significantly reduced cost and complexity whilst maintaining the required level of pointing precision.

### SUMMARY

Disclosed, in various embodiments, are spatial tracking systems. Specifically, the disclosure relates to numerically controlled two axes tracking systems.

In an embodiment, provided herein is a high precision tracking system having adaptive two axis angular velocity comprising: a pedestal coupled to a foundation; a slew drive comprising a modular velocity rotation driver operably coupled to the pedestal; an azimuth yoke having a fore side and an aft side operably coupled to the slew drive at the fore side and hingedly coupled to an elevation hub comprising a modular velocity elevation driver, operably coupled to the azimuth yoke; a directional apparatus configured to be precisely pointed towards a target, operably coupled to the elevation hub; and a processor operably coupled to the tracking system.

In another embodiment, provided herein is a cluster, comprising: a plurality of the tracking systems described herein, the tracking systems being in electronic communication with a cluster central processing unit (CCPU).

In another embodiment, provided herein is a spatial tracking systems capable of quickly adapting the system's angular velocity and pointing accuracy to the tracked target's specifics by changing modular gear units in the gear train of the motorized azimuth and elevation drives.

In one embodiment, the tracking system may comprise a radiation concentrator as described in U.S. Pat. No. 7,156,531 disclosing a parabolic concentrator, incorporated herein by reference in its entirety to the disclosure of this application for all purposes.

These and other features of the spatial tracking systems will become apparent from the following detailed description when read in conjunction with the drawings, which are exemplary, not limiting, and wherein like elements are numbered alike in several figures.

### BRIEF DESCRIPTION OF THE FIGURES

For a better understanding of the spatial tracking systems, with regard to the embodiments thereof, reference is made to the accompanying drawings, in which like numerals designate corresponding elements or sections throughout and in which:

FIG. 1 shows a general isometric view of an embodiment of the spatial tracking systems;

FIG. 2 shows an exploded assembly view of the principal components of an embodiment of the spatial tracking systems;

FIG. 3 shows an isometric view of the elevation hub of an embodiment of the spatial tracking systems;

FIG. 4, is an exploded assembly view of the azimuth yoke of an embodiment of the spatial tracking systems;

FIG. 5, shows an exploded assembly view of the slew drive's gear train;

FIG. 6, shows an exploded assembly view of the elevation drive's gear train;

FIG. 7, shows a schematic depicting the general input/output stream of the tracker's on-board processor; and

FIG. 8, shows a network operational scheme depicting the supervision, operation and control of several clusters of trackers, either local or remote.

### DESCRIPTION

The present disclosure thus provides in a first aspect, a high accuracy, two axis tracking system that is insensitive to the distance of the tracked object, comprising: a rigid pedestal which can serve as an attachment base for the tracking system, with sufficient height to provide interference-free movement of the installed directional apparatus; a motorized slew drive for generating the desired azimuthal motion. The slew drive is configured to have a modular and quick exchangeable gear train for rapidly obtaining the desired combination of azimuthal angular velocity and pointing accuracy, which can enable continuous tracking of a target with only minimal angular accelerations and no direction reversals. The tracking system can further comprise a clutch or torque limiting system capable of disconnecting the slew drive at excessive torques, enabling the tracking system to realign itself to the wind into a trimmed condition. An azimuth yoke can be incorporated, consisting of assembled steel plates operably coupled to the slew drive, where the plates can have provisions for the elevation shaft, with a screw gear drive and auxiliary systems; a central hub comprising a bored face plate (or mounting bracket) for mounting the directional apparatus, a horizontal elevation rotational shaft and an elongated control horn simultaneously serving as an elevation moment multiplier and a coupling point for the elevation drive. The system can further comprise two high precision angular motion encoders, operably coupled to the drive or rotational shafts of either the azimuth or elevation drives, for precisely and accurately measuring the azimuth and elevation angles. In an embodiment, the term “encoder” is a general term including any device suitable for performing continuous angular or linear measurements and transmission of the resulting signals to a receiving and processing unit. The term “encoder” refers to displacement transducers in which the interaction between the stationary and moving elements is based on a repetitive pattern, with a either binary or continuous output signal. The encoders can be, for example, optical or capacitive, full-rotation, absolute angle encoders, which can convert rotation angle into an output signal based on interaction between a fixed and a moving part. These encoders can be built to provide an output signal that repeats once or more times per rotation.

The elevation hub used in the tracking systems described herein can have a geared screw drive for generating the desired elevation motion of the directional apparatus. The screw-drive can be configured to have a modular and quick exchangeable gear train for rapidly obtaining the desired combination of elevation angular velocity and pointing accuracy, which can enable continuous tracking of the intended target with only minimal angular accelerations and minimal direction reversals. The screw-drive can be operably coupled to the elevation hub's control horn above the elevation rotation axis, thus ensuring that the elevation drive screw is always loaded in tension—eliminating expensive over dimensioning of the elevation drive due to Euler buckling of the screw, or threaded shaft.

The processor used in the spatial tracking systems described herein can comprise: a user interface; a transceiver; and a non-volatile memory, wherein the processor is configured to receive data from a plurality of onboard and external sensors and/or systems. A closed loop, low order control system can be incorporated into the processor, which can measure the pointing error and execute correcting commands to the tracking system for minimizing the tracking error. The control system can also activate auxiliary subsystems such as pumps, fans, lights, heating coils or other similar system comprising at least one of the foregoing or their combination in accordance with predefined control algorithms and environmental sensor scripts stored in the processors memory. Scripts and other algorithms can be uploaded into the processor remotely, using any suitable communication means, for example, wired, wireless, internet, radio and other electronic communication means. The control system used in the spatial tracking systems described herein can also use a variety of on-board, environmental, remote or satellite-based sensors to determine if the environmental operational limits are exceeded thereby driving the tracking system into a predefined protective stow position. The control system used in the spatial tracking systems described herein can also comprise a high-order control system, which can enable a single tracking system to operate as a part of a network of tracker clusters; either local or remote. The high order control system can be configured to further report the operating status of each networked tracking system to either a local or a remote manned or autonomous supervising station by means of a cabled, internet, wireless connection or electronic connection.

In an embodiment, the term “electronic communication” indicates that one or more components of the tracking systems described herein are in wired or wireless communication or internet communication so that electronic signals and information can be exchanged between the components in a bidirectional manner.

The slew drive used in the spatial tracking systems described herein can comprise an inner ring coupled to the pedestal and an outer housed ring coupled to the azimuth yoke. The height of the pedestal can be configured to provide the directional apparatus, with uninterrupted pitch from about 6° below the horizon, to 90° above the horizon. Likewise, the slew-drive can continuously rotate the directional apparatus 360°. Likewise, the pedestal may be fabricated from metal or concrete or a combination thereof and further stiffened by means of external or internal bracing comprising a combination of wires, ropes, tubes, bars or struts. The directional apparatus can be, for example, an antenna of arbitrary form, a dish-like energy concentrator, an energy concentrator of arbitrary form, a pointing device, an illumination device, a listening device, a microphone device, an imaging device, a data collecting or transmitting device or a pointing device comprising at least one of the foregoing.

The elevation hub used in the spatial tracking systems described herein may further comprise a mounting bracket having a front coupled to the directional apparatus and a back side coupled to a cylindrical housing. The housing can have any appropriate cross section and does not necessarily have a cylindrical cross section. In an embodiment, the housing can also have a square or hexagonal cross section. The housing coupled to the mounting bracket can also be hingedly coupled to the azimuth yoke. The mounting bracket may further have a control horn disposed thereon, that can be configured to hingedly couple to a threaded shaft used in the screw-gear of the elevation hub.

The term “hingedly” refers in an embodiment, to a coupling of one or more components which allow the second component to pivot with respect to the first component. “Hingedly” can also refer to a method of mounting one component to another such that the two components can hinge or move relative to one another, and is not intended to be limited to a connection comprising an actual hinge. “Hingedly coupled” indicates that the orientation of one component relative to the other can be varied. This may be because of a form of mechanical connection that permits relative movement, for example a pivot, a rod end, or a hinge pin. There may be an intermediate portion which is hinged at respective spaced locations to the first and second portions, allowing a greater degree of hinging in one or more directions. A hinging device may be lockable. Hinged portions may be separable.

The elevation hub used in the spatial tracking systems described herein can further comprise: a trunnion mount, hingedly coupled to the aft side of azimuth yoke; a linear screw drive having a proximal end operably coupled to the control horn via a rod end clevis, and a distal end coupled to the trunnion mount via a bearing. Moreover, the linear screw drive can be driven by a controllable and reversible electrical motor, a pneumatic device, a hydraulic device or any driving mechanism comprising at least one of the foregoing. In addition, the linear screw gear is operably coupled a train of serially coupled and interchangeable modular gear units configured to modify the linear screw drive's unit angular velocity by changing the total gear ratio as a response to varying requirements in the angular elevational velocity. As used herein, the term “interchangeable” indicates that the gear unites used in the spatial tracking systems described herein can be used in any order that will provide the required angular elevation velocity. For example, the gear units can be used to increase angular elevation mobility by sequentially increasing the ratio between the driving mechanism and the screw drive, thus able to track high velocity and/or short range, without compromising pointing accuracy. In an embodiment, the spatial tracking systems described herein have a pointing accuracy of angular elevation of between ±0.005 to ±1.0 milliradian (mrad) Likewise, the spatial tracking system described herein can be configured to provide angular elevation velocity of between about 0.001 degree per second (deg./sec) to 3.0 deg./sec.

The azimuth yoke used in the spatial tracking systems described herein can extend rearwards, away from the tip of the directional apparatus and can act as a ballast to the directional apparatus, thus generally alleviating the elevation moment vis à vis the elevation shaft. The azimuth yoke can be operably coupled to the slew drive, which, like the screw-drive can be powered or motorized by a controllable and/or reversible electrical motor, a pneumatic device, a hydraulic device, or a device comprising at least one of the foregoing. The slew drive can also be operably coupled to a train of serially coupled interchangeable modular gear units, configured to modify the slew drive's unit angular velocity by changing the total gear ratio as a response to varying requirements in the angular rotational velocity. For example, the gear units can be used to decrease angular rotational velocity by sequentially increasing the ratio ratio between the driving mechanism and the slew drive, thus enable to track low angular velocity and/or long range objects, with high pointing accuracy. In an embodiment, the spatial tracking systems described herein have a pointing accuracy of angular rotation of between ±0.005 to ±1.0 milliradian. Likewise, the spatial tracking system described herein can be configured to provide angular azimuthal rotational velocity of between 0.001 degree per second (deg./sec) to 3.0 deg./sec.

The spatial tracking systems described herein can be constructed from any material capable of carrying the loads and torsions required from the operation of the spatial tracking systems described herein. Possible materials can be for example, aluminum, steel, titanium and the like.

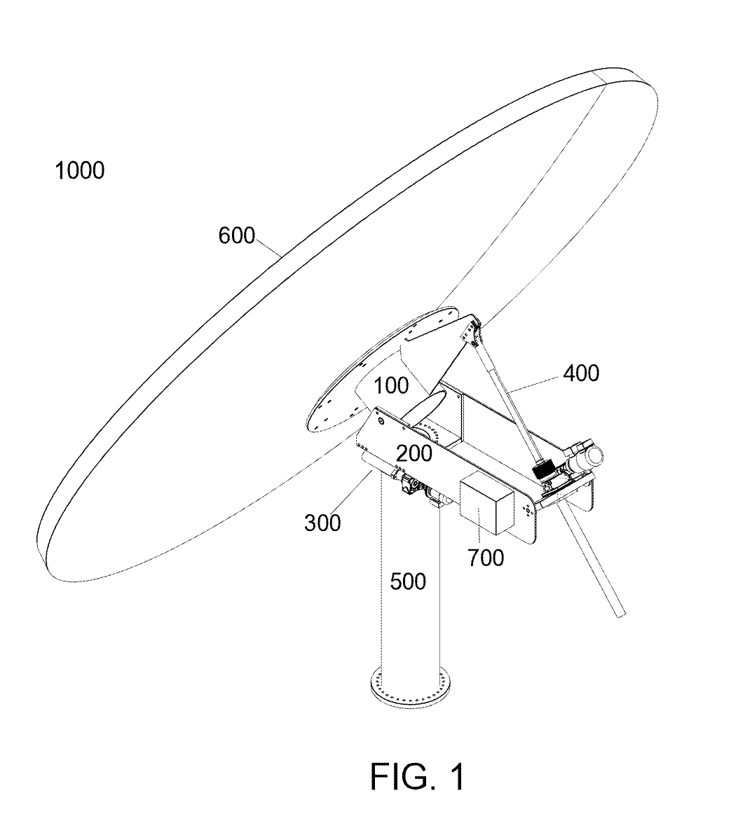

In an embodiment, provided herein is a two axis (elevation and azimuth) tracking system 1000 for the purpose of tracking target types, having a wide range of perceived angular velocities, with a higher degree of accuracy at a lower cost and complexity than has hitherto been possible. Turning now to FIG. 1 which is a general isometric view of the two axis tracking system 1000 constructed in accordance with a preferred embodiment of the present invention. A pedestal 500, operably coupled to a foundation, supports the tracking system. The pedestal is sufficiently elevated from the ground to allow directional apparatus 600 adequate obstacle clearance at its most depressed angle of elevation. The directional apparatus 600 can be coupled to the elevation hub 100 by means of a plurality of mechanical fasteners. The directional apparatus 600 depicted in FIG. 1 can be, for example, an illumination device, an energy concentrating device, a pointing device, a microphone device, an imaging device, a data collecting or transmitting device or any other device that requires for its operation the continuous precise positioning in azimuth and elevation.

The desired azimuth angle can be achieved by the activation of a motorized slew drive 300 and the desired elevation angle can be achieved by the activation of a motorized screw drive 400 connected to the elevation hub 100. The elevation hub 100 has a horizontal rotational degree of freedom relative to the azimuth yoke 200, which can be operably coupled to the slew drive 300. The slew drive can have a vertical rotational degree of freedom. The outer ring hosed in the slew drive can be operably coupled to the azimuth yoke and the inner ring housed in the slew drive can be coupled to the pedestal 500; the internal gear can be configured to rotate the outer ring relative to the fixed inner ring.

The operation and control of the pitch and rotation axes of the tracker 1000 can be performed by a processing unit. Said processing unit can be configured to receive information from a plurality of onboard and external sensors, and can be configured to execute control commands to the drive motors. The sensors, processing and controller units can be housed in a group of temperature controlled weather proof units 700. The processing unit can also control and operate auxiliary system units such as: pumps, fans, deicing devices, chillers, heating elements, lamps, cameras, loudspeakers, warning systems etc. In an embodiment, the entire system 1000, all the mechanical fasteners and directional devices can be such that it survives at legally required maximum wind speeds and safety margins.

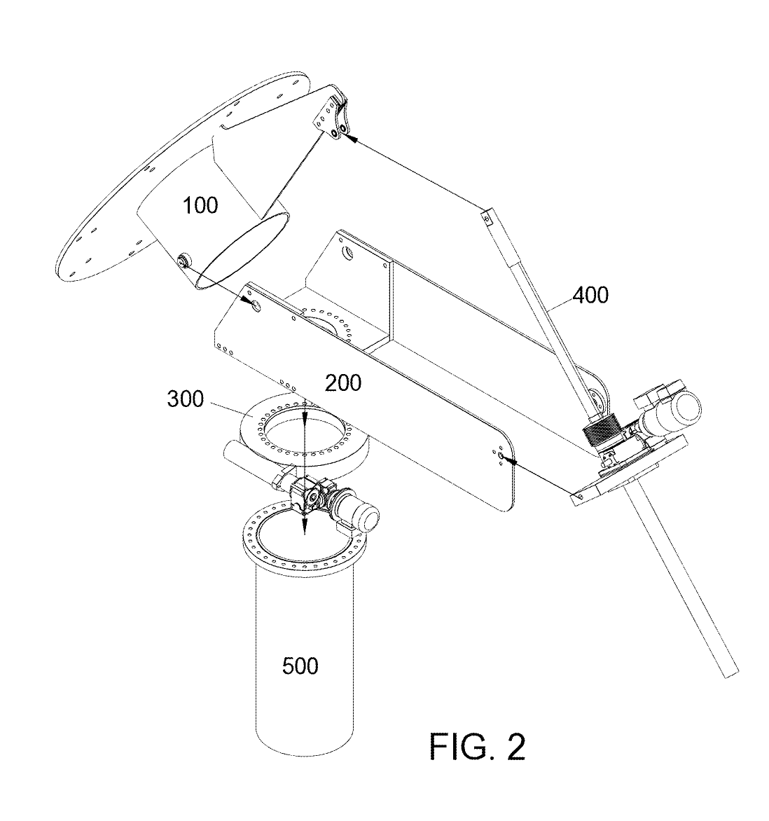

Turning now to FIG. 2, which depicts an exploded isometric view of an embodiment of the spatial tracking system described, showing its part breakdown. Pedestal 500 is operably coupled to a ground foundation and may be further stiffened, and/or made rigid by auxiliary external bracing elements such as, for example, wires, tubes or struts. The motorized slew drive unit 300 can be mounted to the pedestal 500 by a circumferential array of precisely tensioned steel bolts. The azimuth yoke unit 200 can be further coupled to the slew gear's by a further concentric array of precisely tensioned steel bolts. The elevation hub 100 can be mounted to the azimuth yoke 200 with a substantial horizontal rotational degree of freedom. The desired angle of elevation can be achieved by a motorized geared screw drive 400 which can be operably coupled both to the elevation hub 100 and to the azimuthal yoke 200.

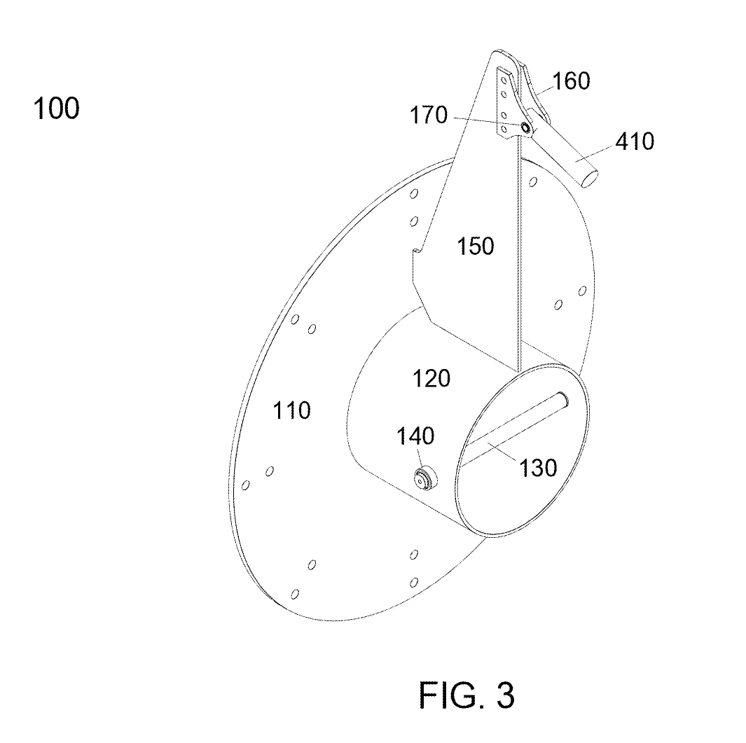

Referring now to FIG. 3, which depicts an isometric view of the elevation hub 100. The purpose of said elevation hub 100 can be to simultaneously provide means for attaching the directional apparatus to the tracking unit while accurately achieving the desired elevation angle. The directional apparatus can be coupled to faceplate 110 by means of a plurality of mechanical fasteners. The faceplate 110 can be machined plane and drilled in a pattern exactly matching the directional apparatus' mating holes. As shown in FIG. 3, a cylindrical steel housing 120 with a horizontal steel shaft 130 can be operably coupled to the face plate 110. The shaft protrudes from the cylindrical housing and can be fitted to a pair of spherical bearings 140 at each end. The bearings provide an elevational rotational degree of freedom of the steel shaft and can also compensate for manufacturing and alignment errors, thus making the system more robust. Vertical control horn 150 can provide means for coupling the elevation drive to the hub and augment the pitching moment for a given force exerted by said drive. Control horn 150 can be operably coupled to both face plate 110 and central cylindrical housing 120. The control horn 150 can be tapered towards its tip, where a pair of ears 160 may be installed to facilitate the connection of the screw drive's rod-end clevis 410. The ears 160 may be equipped with spherical bearings 170 to enhance the accuracy of the connection and to compensate for manufacturing and alignment errors. The sizing of the steel components comprising the elevation hub 100 can be performed using, for example, Finite Element Analysis based on the limit loads of the directional apparatus, ensuring that the maximum strength of the unit can be obtained at the minimum weight and cost.

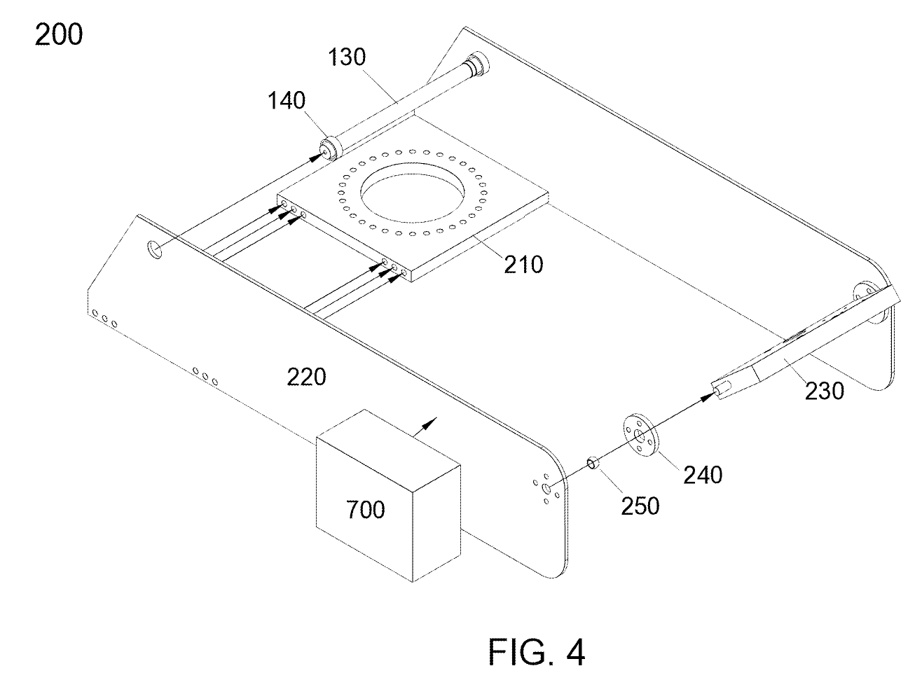

Referring now to FIG. 4, which depicts an isometric exploded view of the azimuth yoke unit 200. Yoke unit 200 can consist generally of assembled flat metal plates; reducing overall costs while eliminating internal stresses and deformations due to welding. The horizontal base plate 210 can be machined flat and drilled in a pattern exactly matching the hole pattern of the slew drive's ring. It may have a central orifice for reducing overall weight and enabling routing of cables, tubes, hoses, wires etc. Flat vertical side plates 220 can be coupled to the base plate 210 by means of mechanical fasteners. Said fasteners and connection layout can be sized to sustain the maximum legal loads, including the required safety margins, of the tracking unit. The forward upper part of side plates 220 can be machined precisely to house the spherical bearings 140 of the shaft 130. Side plates 220 extend horizontally aft and can serve the plural purposes of: (i) providing means for attachment for the screw-drive's trunnion mount 230; (ii) acting as counter weights to the installed directional apparatus; and (iii) providing a convenient mounting surface for the control boxes 700 housing the onboard electronics and electrical equipment. The screw drive's trunnion mount 230 can be coupled to the aft upper part of the side plates 220. A short shaft can protrude from each lateral side of trunnion mount 230 and can be fitted with spherical bearing 250. The bearing 250 can be caged in a housing 240, which can be coupled to the side plates 220 by tensioned mechanical fasteners.

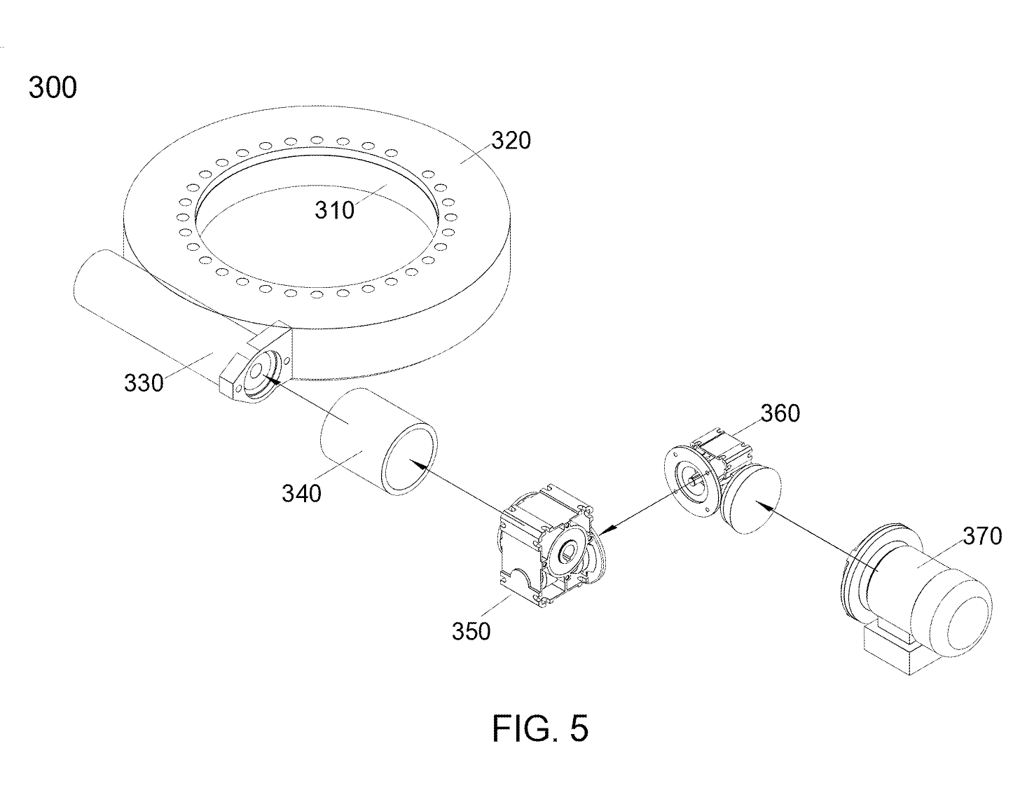

Referring now to FIG. 5, which depicts an isometric exploded view of the motorized slew drive unit 300 and its associated modular gear train. The principal slew drive may consist of typically three units: (i) inner ring 310 which can be operably coupled to the pedestal 500 (not shown); (ii) an outer ring with top housing 320 which can be operably coupled to the azimuth yoke 200 and worm gear unit 330 which can be configured to drive outer ring 320 to its desired azimuthal position with high accuracy. The size of the slew drive can be determined by, for example, the maximum operational loads that the system can be required to sustain. This in turn may be a function of the directional apparatus used, choice of materials used for fabrication, operational tolerances at the installation location and other factors. The total gear ratio of the slew drive unit can be the product of worm gear's 330, second stage modular gear 350 and third stage modular gear 360. An optional variable friction unit 340, for example: a clutch unit or a torque limiter, may be incorporated behind the worm gear 330 should there be a requirement that at large wind loads the directional apparatus will “wind vane” into a trimmed protective position having minimal azimuthal torque. In order to avoid system loads due to starting, stopping and angular accelerations, the angular velocity of the slew drive can be closely matched to the desired target's angular velocity. This can be achieved by, for example, determining the desired total gear ratio of the gear train. Since the second and third stage gear units are modular and can be quickly exchangeable, the slew gear unit's angular velocity can be rapidly adapted to different targets' angular velocity. The desired azimuthal angular velocities may range from fast moving low flying aircrafts to virtually static astronomical targets. A reversible and/or speed controllable electrical motor 370 can drive the slew gear unit to the desired position. Electrical motor 370 may be controlled by a processing unit commanding a variable speed unit for fine tuning the tracking of the intended target to a high degree of accuracy. Electrical motor 370 may be either: (i) single phase alternating current; (ii) three phase alternating current; or (iii) a direct current motor.

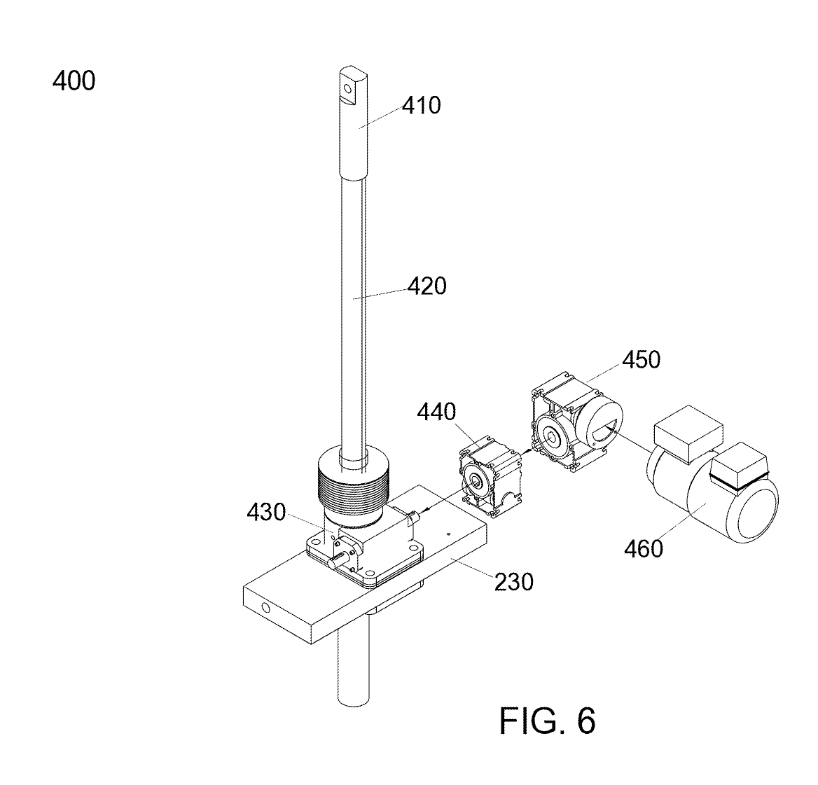

Turning now to FIG. 6, which depicts an isometric exploded view of the motorized screw drive unit 400 and its associated modular gear train. The exact positioning of the drive screw can be configured to achieve the hub's desired elevation angle. The screw jack worm gear housing 430 can be operably coupled to the trunnion mount 230. The screw gear 420 can extend or retract according to the commands issued by the processing unit. The length of the screw gear 420 can be calculated from the limit depression and elevation angles below and above the horizon. The diameter of the screw gear 420 can be determined by the maximum axial loads. Dimensioning a screw gear 420 for compression loads can result in an oversize screw due to Euler buckling effects, which are not present when the screw is loaded in tension. In an embodiment, the tracking systems disclosed herein ensure that the jack screw can be solely loaded in tension, assuring that the screw diameter can be optimally matched to the generated loads—thus ensuring minimum costs and weight without expensive over-dimensioning. These goals can be obtained by, for example, ensuring that screw drive rod end clevis 410 can be coupled to the hub above the horizontal axis of rotation. In order to avoid system loads due to starting, stopping and angular accelerations, the angular velocity of the elevation hub can be closely matched to the desired target's angular velocity. This can be achieved by determining the desired total gear ratio of the screw drive's gear train. Secondary 440 and optionally tertiary 450 modular gear units can be coupled in series to worm gear 430. Since the second and third stage gear units are modular and can be quickly exchangeable, the screw drive unit's linear velocity can be quickly adapted to different targets' angular velocity. The gear train can be driven by a reversible electrical motor 460, said electrical motor may be controlled by a processing unit commanding a variable speed unit for fine tuning the tracking of the intended target to a high degree of accuracy. The electrical motor may be either: (i) single phase alternating current; (ii) three phase alternating current; or (iii) a direct current motor.

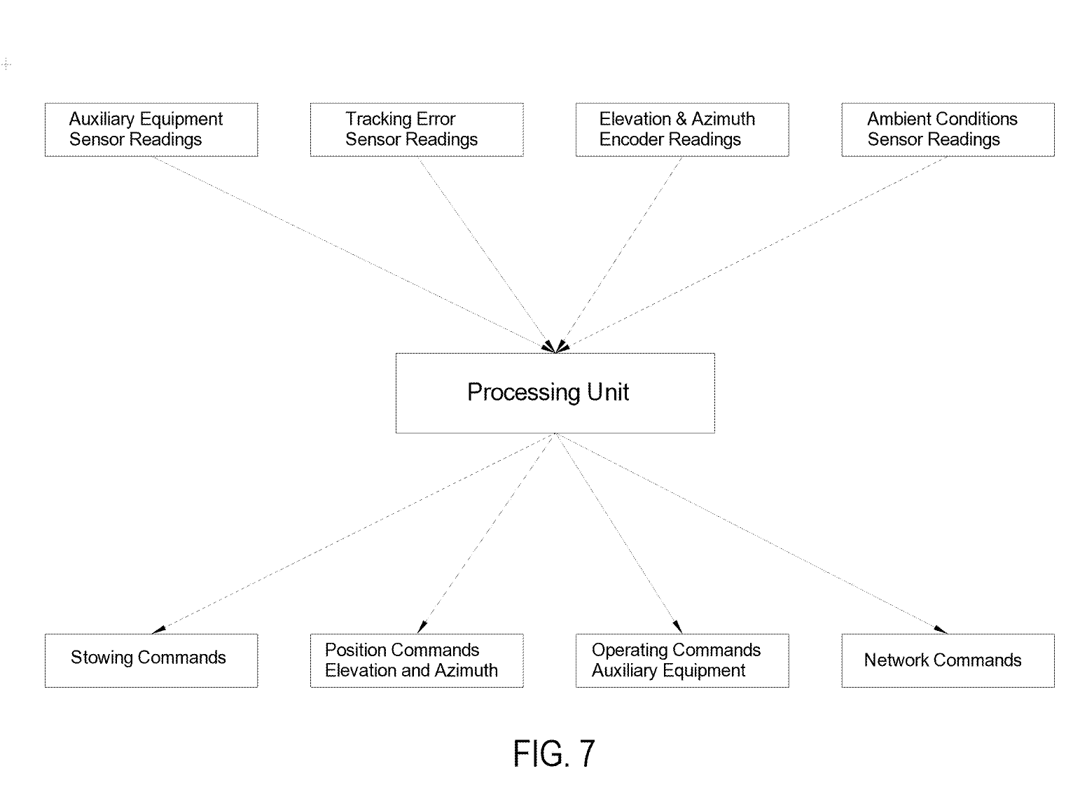

Turning now to FIG. 7, depicting a scheme for controlling the tracker and its subsystem. The tracking system's processing unit can be configured to continuously receive inputs from a plurality of both onboard and external sensors, which communicate with the processor either by cable, internet or wireless communication or a combination thereof. The onboard processing units can compile all the data received in accordance with its internal algorithms and executes the associated commands and instructions to the client systems, either onboard or remote systems. An example of control scheme, is provided herewith, whereas variations of said scheme may be implemented at any time in accordance with varying system requirements by modifying or replacing the sensor layout and/or the processor's control algorithms.

The elevation and azimuth encoder readings provide the position of the elevation and azimuth angles. The encoder readings, combined with tracking error sensor readings, enable the processor to issue control commands to the drive motors of both the azimuth and elevation drives to the desired position. Auxiliary sensor readings, such as, for example, pressures, temperatures, vibrations, strains, velocity, mass flow etc. can be used by the processor to control the auxiliary equipment that may be used by the tracking system, such as: pumps, fans, chillers, deicing, heating elements, lights, cameras, warning systems etc. Ambient conditions sensor input can be typically obtained from a weather station serving a plurality of trackers. The data from the weather station may be communicated to the processor either by cable, internet or wireless means. Typically, ambient weather data input is used to determine whether the system's operating limits are exceeded and if a protective stow command has to be executed.

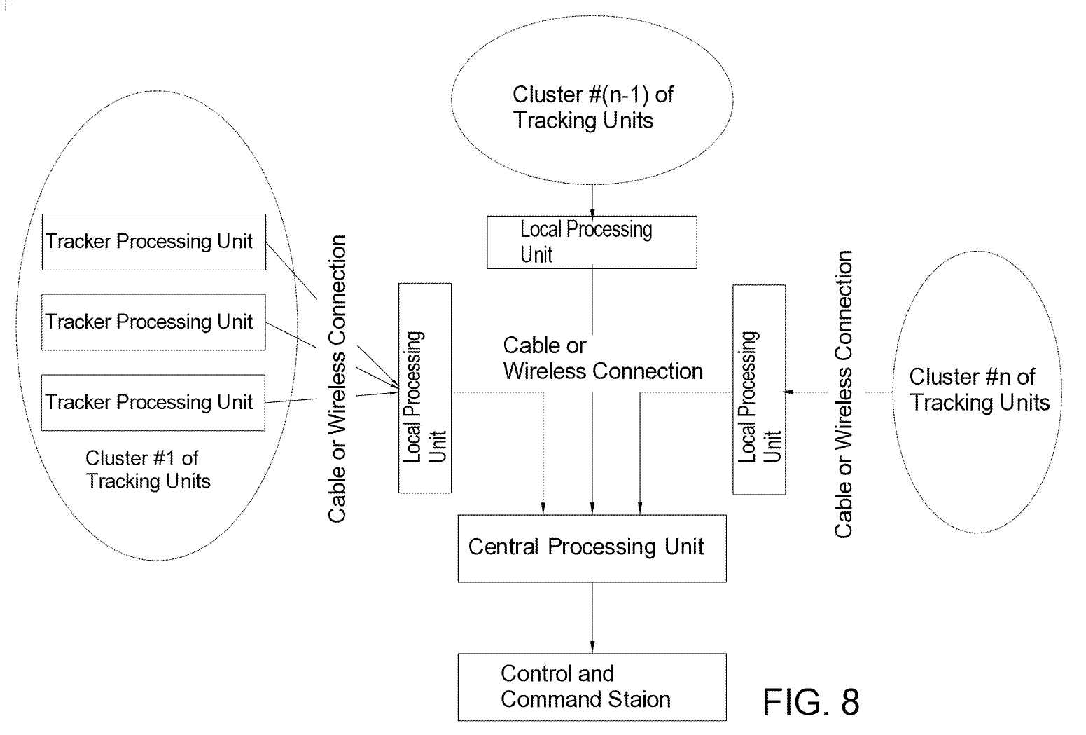

Turning now to FIG. 8, showing a network scheme for controlling a plurality of tracker clusters. The two axis tracker described herein may operate either individually or as a part of a cluster. Furthermore, globally dispersed clusters may interact with each other to obtain the desired result. The following discussion relates to an example of a tracker networking with n clusters of tracking units. In a local cluster of trackers each onboard processing unit can report to a local processing unit. The communication between the trackers and the local processing unit may be either by cable or wireless or a combination thereof, which can continuously receive and transmit data as required. Said local processing units can communicate with a remote central processing unit, which may continuously receive data and transmit commands and data to the local processing units. The control and supervision of the central processing unit may be either local or remote by a control and command station, which may be manned or autonomous. The connection with the central processing unit may be by cable, wireless or internet or a combination thereof. The tracker cluster may, for example, be located in the Chilean Andes, the Central Processing Unit in California and the Control and Command Station in Tel-Aviv, all communicating by satellite and/or internet.

All ranges disclosed herein are inclusive of the endpoints, and the endpoints are independently combinable with each other. Furthermore, the terms “first,” “second,” “secondary”, “tertiary” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “coupled”, including its various forms such as “operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection.

The term “about”, when used in the description of the technology and/or claims means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such and may include the end points of any range provided including, for example ±25%, or ±20%, specifically, ±15%,or ±10%, more specifically, ±5% of the indicated value of the disclosed amounts, sizes, formulations, parameters, and other quantities and characteristics.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A high precision two axis tracking system having adaptive angular velocities comprising:
a pedestal like unit coupled to a foundation;
an elevation hub comprising a horizontal rotational degree of freedom;
an azimuth yoke operably coupled to the elevation hub;
a slew drive unit for azimuth positioning, comprising an inner ring and an outer ring, one ring rigidly coupled to the pedestal and one ring coupled to the azimuth yoke;
a linear screw drive unit for elevation positioning, simultaneously coupled to the elevation hub and the azimuth yoke;
directional apparatus to be precisely pointed towards a target;
encoders operably coupled to rotational shafts; and
a processing unit for controlling and networking the tracking system with associated auxiliary systems.

2. The system of claim 1, wherein said directional apparatus may be an antenna of arbitrary form, a dish-like energy concentrator, an energy concentrator of arbitrary form, a pointing device, an illumination device, a listening device, a microphone device, an imaging device, a data collecting or transmitting device or any apparatus that require for its operation the continuous precise positioning in azimuth and elevation.

3. The system of claim 1, wherein said elevation hub comprises:
a flat mounting surface interfacing with the directional apparatus;
a generally cylindrical housing rigidly affixed to said flat mounting surface;
a flat protruding control horn simultaneously rigidly affixed to said cylindrical housing whilst operably coupled to a linear screw drive; and
a horizontal shaft protruding from said housing whilst supported by at least one bearing.

4. The system of claim 3, wherein said control horn is tapered, elongated and located above the horizontal rotational shaft for the purpose of increasing the linear screw drive's elevation moment whilst ensuring that said linear screw is solely loaded in tension, thus eliminating over-dimensioning of said linear screw due to Euler slender budding.

5. The system of claim 1, wherein the azimuth yoke comprises generally flat metal plates incorporating interface provisions for the slew drive, the linear screw drive, the elevation hub, a plurality of control boxes and routing devices.

6. The system of claim 5, wherein the azimuth yoke extends rearwards acting as a ballast to the directional apparatus, thus generally alleviating the elevation moment vis a vis the horizontal shaft.

7. The system of claim 1, wherein said pedestal unit may be fabricated from metal or concrete or a combination thereof and further rigidized by means of external or internal bracing comprising a combination of wires, ropes, tubes, bars or struts.

8. The system of claim 1, wherein the slew drive is powered by a controllable and/or reversible electrical motor, a pneumatic device, a hydraulic device, or a device comprising at least one of the foregoing.

9. The system of claim 8, wherein the motorized slew drive unit is fitted with a train of serially connected modular gear units, said modular gear units being quickly interchangeable and/or exchangeable for the purpose of modifying said slew drive unit's angular velocity by means of adapting the total input gear ratio as a response to varying requirements in the azimuthal angular velocity.

10. The system of claim 8, wherein the motorized slew gear unit is fitted with either a variable friction device, torque limiting device or a clutch device or a combination thereof capable of disconnecting the slew gear unit from the modular gear unit train at a predefined torque, thus enabling the slew gear to float into a trimmed azimuthal position having only a minimal torque.

11. The system of claim 1, wherein the linear screw drive unit is powered by means of at least one controllable/reversible electrical motor, one pneumatic device or one hydraulic device or a combination thereof.

12. The system of claim 1, wherein the linear screw drive is operably coupled to the elevation hub by means of a rod end clevis and to the azimuth yoke by means of a bearing supported trunnion mount.

13. The system of claim 11, wherein the motorized linear screw gear unit is fitted with a train of serially connected modular gear units, said modular gear units being quickly interchangeable and/or exchangeable for the purpose of modifying the screw drive unit's linear velocity by means of changing the total input gear ratio as a response to varying requirements in the elevational angular velocity.

14. The system of claim 1, wherein said processing unit is inputted data from a plurality of onboard and external sensors for the purpose of processing the inputted data by stored algorithms, said algorithms may be adapted to the specific operation of different directional apparatus.

15. The system of claim 14, where a closed loop control algorithm is inputted a measured spatial error of the target tracking, said algorithm may use proportional, integral and differential analysis, or any combination thereof, of new and stored spatial error measurements to issue optimized control command to the azimuth and elevation drive motors for the purpose of rapidly minimizing the tracking error.

16. The system of claim 14, where a control algorithm is specifically inputted ambient atmospheric data, said algorithm outputting protective stow commands to the tracking unit should the operational conditions of the system be exceeded.

17. The system of claim 14, wherein said processing unit combined with stored control algorithms issue commands and information to a plurality of auxiliary systems comprising: pumps, fans, chillers, deicing devices, heating elements, lights, cameras, warning systems, computer data storage and processing devices etc.

18. The system of claim 1, wherein said tracking device operates either as a single unit or as part of a plurality of trackers grouped in a cluster, said cluster of trackers generally supervised and controlled by a local processing unit having either cabled, wireless or internet network connection or a combination thereof to each tracker.

19. The system of claim 18, wherein clusters of trackers may be globally dispersed and each cluster's local processing unit is networked with a central processing unit, said network connection being either cable, wireless or internet or a combination thereof.

20. The system of claim 19, wherein said central processing unit is controlled by either a local or remote command station, said command station may be manned or autonomous and communicating with the central processing unit either by cable, wireless or internet or a combination thereof.
